(19) United States
(12) Patent Application Publication
(10) Pub. No.: US 2015/0014975 A1
(43) Pub. Date: Jan. 15, 2015

(54) RESCUE DUAL BUCKLE VEHICLE SEAT BELT, AND A METHOD OF ASSEMBLING, AND USING THE SAME

(71) Applicant: Abdullah Ali Bahattab, Jeddah (SA)

(72) Inventor: Abdullah Ali Bahattab, Jeddah (SA)

(21) Appl. No.: 14/156,177

(22) Filed: Jan. 15, 2014

Related U.S. Application Data
(60) Provisional application No. 61/845,261, filed on Jul. 11, 2013.

(51) Int. Cl. B60R 22/32; B60R 22/12

(52) U.S. Cl. CPC B60R 22/32; B60R 22/12
USPC 280/801.1

(57) ABSTRACT

The present invention relates generally to a vehicle seat belt, and a method of assembling, and using the same. More particularly, the invention encompasses an apparatus for providing at least one rescue buckle so as to form a dual buckle vehicle seat belt in a vehicle, and a. method of assembling, and using the same. The invention further comprises a standard three point seat belt system having a standard seat belt buckle along with a separate second or rescue seat belt buckle using the same seat belt strap where either of those two seat belt buckles can be disengaged from their respective receptacles at the time of need or rescue. The seat belt has a first. seat belt buckle secured to one end, while a second seat belt buckle is allowed to slideably move from one end to the other end of the seat belt.

### CROSS-REFERENCE TO RELATED APPLICATION

The instant patent application claims priority to and the benefit of pending U.S. Provisional Patent: Application Ser. No. 61/845,26, filed on Jul. 11, 2013, titled “A Rescue Dual Buckle Vehicle Seat. Belt, And A Method Of Assembling. And Using The Same,” the entire disclosure of which provisional application is incorporated herein by reference.

### FIELD OF THE INVENTION

The present invention relates generally to a vehicle seat belt, and a method of assembling, and using the same. More particularly, the invention encompasses an apparatus for providing at least one rescue buckle so as to form a dual buckle vehicle seat belt in a vehicle, and a method of assembling, and using the same. The invention further comprises a standard three point seat belt system having a standard seat belt buckle along with a separate second or rescue seat belt buckle using the same seat belt strap where either of those two seat belt buckles can be disengaged from their respective receptacles at the time of need or rescue. The seat belt has a first seat belt buckle secured to one end, while a second seat belt buckle is allowed to slideably move from one end to the other end of the seat belt.

### BACKGROUND INFORMATION

Vehicle seat belts come in different shapes, sizes, and positions in vehicle's seat, and have been known and used for many years, and for a variety of reasons, and especially, for the safety and security of occupants, such as passengers.

U.S. Pat. No. 4,796,915 (Michael S. Kaurich, et al.), the entire disclosure of which is incorporated herein by reference, discloses a seat belt extender for positioning a seat belt being unwound from a seat belt retractor includes two or more multi-plastic sleeves telescopically slidable relative one another between retracted and extended positions and having belt passages through which the belt passes from the retractor toward the occupant. A detent mechanism acts between the belt and the end-most of the sleeves to releasably couple the belt and the end-most of the sleeves so that the unwinding and extension of the belt from the retractor causes the belt to carry the endmost sleeve therewith and thereby extend. the other sleeve to their extended positions so that the sleeves support the belt at a lifted position relative to the occupant. An additional detent means acts between each pair of adjacent telescoping: members to retain the telescoping members at their relative extended positions relative one another and are then releasable to permit the telescoping members to retract relative one another to lower the belt to the close fitting relationship around the occupant when the door is closed and the belt is retracted.

U.S. Pat. No. 5,123,673 (Omar D. Tame), the entire disclosure of which is incorporated herein by reference, discloses a seat belt system for use with a vehicle seat which includes a three point belt system forming a lap belt and a shoulder belt and further includes a second shoulder belt to form a four point system. The belt system includes a presenter mechanism to move the clasp for the three point portion of the system into an easy to reach position to encourage seat belt usage. The system includes two buckles on opposite sides of the seat with a release mechanism provided to automatically release one buckle upon the manual release of the other buckle regardless of which buckle is first manually released.

U.S. Pat. No. 5,570,933 (Stephen W. Rouhana, et al.), the entire disclosure of which is incorporated herein by reference, discloses a seat belt assembly in a vehicle for restraining an occupant and includes a lap-shoulder belt assembly and an lap-shoulder belt extender assembly. The lap-shoulder belt includes a shoulder belt, having an upper end mounted to the vehicle and a lap belt having a first end mounted to the vehicle and a second end joined to the lower end of the shoulder belt to form a lap-shoulder belt junction. The extender belt includes an extender shoulder belt and an extender lap belt. The extender shoulder belt has an upper extender end adjustably coupled to the shoulder belt. The extender lap belt, has a first lap extender end releasably connected to the lap-shoulder belt junction and a second lap extender end connected to a lower extender end of the extender shoulder belt to form an extender junction. The extender junction is releasably connected to the vehicle at the normal location of the lap-shoulder belt junction,

U.S. Pat. No. 6,116,696 (Aaron M. Widman, et al.), the entire disclosure of which is incorporated herein by reference, discloses a detachable three point seat belt system having an interlocking mechanism that, requires the wearer to reattach a detached system to the seat prior to fastening the seat belt over the wearer's body. This invention specifically addresses the need of three point seat belt systems, which will operate at any seating position within the vehicle, including a front seat, a rear seat, a side seats and/or a center seat within the vehicle. This invention provides a nearly foolproof three-point continuous seat belt system while maintaining significant design flexibility, including detachability and seat adaptability.

U.S. Pat. No. 6,902,194 (Jeff A. Russell, et al.), the entire disclosure of which is incorporated herein by reference, discloses a detachable three point seat belt assembly. The seat belt assembly may have a belt extending downward along a seat from a retractor. In an anchored configuration, the distal end of the belt is attached to a static attachment feature by an interlocking buckle, A movable attachment feature coupled to the belt is engaged within a static buckle to buckle a vehicle occupant into the seat. In a free configuration, the interlocking buckle is disengaged from the static attachment feature so that the belt can be retracted along the seat. The interlocking buckle contains a latching lever and a pair of ejectors that operate in such a manner that insertion of the movable attachment feature enables withdrawal of the static attachment feature, and vice versa.

U.S. Pat. No. 6,969,122 (David A. Sachs, et al.), the entire disclosure of which is incorporated herein by reference, discloses a seat belt extender which has a length of material having, limited flexibility, with a male seat belt latch tongue extending from one end and a female seat belt latch receptacle extending from the opposite end. The seat belt extender is installed in an existing, conventional three point seat belt system in a vehicle by inserting the tongue into the receptacle of the short anchor strap generally located at the inboard side of the seat, near the center of the vehicle. The semi-rigid nature of the present extender causes it to remain generally upright when secured to the anchor strap, thus enabling a person having limited upper body mobility to easily access the receptacle end of the extender with the tongue of the existing belt and shoulder strap assembly. The present extender also serves to position the shoulder strap more toward the center of the upper body of an occupant.

U.S. Pat. No. 7,156,469 (Johnny R. Kennedy, Sr.), the entire disclosure of which is incorporated herein by reference, discloses a three-point seat belt system adapted for use with a seat frame having a seat back and a seat bottom, wherein the system comprises: (a) retractor shoulder belt with a single first connector on its distal end, adapted to be fixedly attached at its opposite end to the underside of said seat bottom, and extending to the front side of said seat back; (b) multi-connecting lap and shoulder belt comprising; (i) seat belt webbing connected to a Y-junction; (ii) a second connector consisting of a post connector attached to one end of the Y-junction, which releasably attaches to said first connector; and (iii) a third connector consisting of a tongue connector attached to the second end of the Y-junction; and (c) a single lap belt with a fourth connector consisting of a buckle on its distal end, which releasably attaches to said third connector.

U.S. Patent Publication No. 20070205650 (Elisabeth Weinstein), the entire disclosure of Which is incorporated herein. by reference, discloses a seat belt buckle extender and method which enhances convenience and decreases problems associated with using safety restraints with child booster seats. The seat belt buckle extender has a seat belt latch plate on one end and a seat belt buckle on an opposite end. The extender has an additional lengthening segment to improve the position of the buckle relative to the child booster seat,

U.S. Patent Publication No. 20110101765 (Brian Matthew Brents), the entire disclosure of which is incorporated herein by reference, discloses a seat belt extender having a rigid non-flexible elongated flat strap with a male connector attached to a first end of the rigid non-flexible elongated flat strap for removably engaging a female connector attached to the floor of an automobile of a three point seat belt and shoulder strap restraint system, and a female connector attached to a second end of the rigid non-flexible elongated flat strap for removably engaging a male connector of the three point seat belt and shoulder strap restraint system. The rigid non-flexible elongated flat strip will stand upright when removably attached to the female connector and has a length that is between two and sixteen inches. The rigid elongated flat strip also has a bend that will locates the female connector of the seat belt extender sideways out away from the site of the seat by a distance of between one inch and four inches when removably attached to the female connector.

This invention improves on the deficiencies of the prior art and provides an inventive rescue dual buckle vehicle seat belt, and a method of assembling, and using the same.

### Purposes and Summary of the Invention

The invention in one aspect is a rescue dual buckle vehicle seat belt, and a method of assembling, and using, the same.

Therefore, one purpose of this invention is to be able to rescue a person or a passenger wearing a seat belt in a vehicle in case the seat belt system has been locked because of a fire in the vehicle or caught in a vehicle that was caused by vehicle accident.

Another purpose of this invention is to provide a cost effective, and durable novel dual buckle vehicle seat belt in a vehicle where both buckles are on the same seat belt strap.

Yet another purpose of this invention is to provide as dual buckle vehicle seat belt in a vehicle where both buckles are on the same seat belt strap, and where one buckle is fixed to one end of the seat belt strap, while the second buckle is free to move along the seat belt strap from one end to the opposite end.

Still yet another purpose of this invention is to provide a three-point seat belt system using a standard seat belt buckle along with a separate second or rescue seat belt buckle using the same seat belt strap where either of those two seat belt buckles can be disengaged from their respective receptacles at the time of need or rescue.

Therefore, in one aspect this invention comprises in a known belt system for restraining a passenger in a seat such as in an automobile, comprising:
a seat belt attached to the vehicle generally above the passenger on a mechanism for automatically winding, and storing the seat belt for storage between uses in a storage position on the door side of the passenger, and attached at another end to the floor directly or indirectly to an anchor; and
a first buckle portion slideably attached to the seat belt, and adapted to engage releasably to a second buckle portion attached to the seat so that movement of the seat belt by the passenger from the storage position to engage the first buckle portion in the second buckle portion results in the seat belt positioned both across the passenger's lap, and across the passenger's chest;
the improvement comprising:
adding a third buckle portion to said seat belt near said anchor, and
adding a fourth buckle portion to said seat belt at the end of the seat belt near the anchor; said third and fourth buckle portions releasably engaging and adapted to be disengaged manually;
whereby, for an emergency the passenger can be released for the seat belt easily by the highly accessible third and fourth buckle portions near the door.

In another aspect this invention comprises a rescue dual buckle vehicle seat belt system, comprising:
(a) a seat belt, having a first end and a second end, and wherein said first end is secured to a frame of a vehicle, and wherein said second end is secured to a first buckle;
(b) a second buckle slideably secured to said seat belt, such that said second buckle slideably moves from said first end to said second end of said seat belt: and.
(c) a car seat, said car seat having a first buckle engaging means on a first side of said car seat, and a second buckle engaging means on a second side of said car seat, and wherein said first buckle engaging means engageably and releasably engages said first buckle, and wherein said second buckle engaging means engageably and releasably engages said second buckle.

In yet another aspect this invention comprises a rescue dual buckle vehicle seat belt system comprising:
(a) a seat belt, having a first end and a second end, and wherein said first end is secured to a frame of a vehicle, and wherein said second end is secured to a first buckle;
(b) a second buckle slideably secured to said seat belt, such that said second buckle slideably moves from said first end to said second end of said seat belt;
(c) a car seat, said car seat having a first buckle engaging means on a first side of said car seat, and a second buckle engaging means on a second side of said car seat, and wherein said first buckle engaging means engageably and releasably engages said first buckle, and wherein said second buckle engaging means engageably and releasably engages said second buckle; and
(d) wherein said car seat has a back and a seat, and wherein said first end is secured to said frame above said back, while said first buckle engaging means and said second buckle engaging means are secured below said seat to said frame.

### BRIEF DESCRIPTION OF THE DRAWINGS

Although the scope of the present invention is much broader than any particular embodiment, a detailed description of the preferred embodiment follows together with drawings. These drawings are for illustration purposes only and are not drawn to scale. Like numbers represent like features and components in the drawings. The invention may best be understood by reference to the ensuing detailed description in conjunction with the drawings in which:

FIG. 1A, illustrates a perspective view of the inventive dual buckle vehicle seat belt system according to a first embodiment of this invention.

FIG. 1B, illustrates an enlarged view of the inventive dual buckle vehicle seat belt system according to a first embodiment of this invention before the dual buckle assemblies are engaged.

FIG. 1C, illustrates an enlarged view of the inventive dual buckle vehicle seat belt system according to a first embodiment of this invention after the dual buckle assemblies have been engaged.

FIG. 2A, illustrates an enlarged view of the male portion of the inventive dual buckle vehicle seat belt system according to a first embodiment of this invention before the male member is engaged to a belt.

FIG. 2B, illustrates an enlarged view of the male portion of the inventive dual buckle vehicle seat belt system according to a first embodiment of this invention after the male member has been engaged with a seat belt.

FIG. 3A, illustrates an enlarged view of the female portion of the inventive dual buckle vehicle seat belt system according to a first embodiment of this invention before the female member is engaged to a short belt.

FIG. 3B, illustrates an enlarged view of the female portion of the inventive dual buckle vehicle seat belt system according to a first embodiment of this invention after the female member has been engaged with a short belt.

### DETAILED DESCRIPTION

The invention in one aspect constitutes an improvement in a known. system for protecting passengers, particularly passengers in an automobile. As an improvement over known systems this invention can be used to retrofit any of the existing three-point seat belt systems.

This invention introduces a new application of the vehicle seat belt, which is rescue the front passengers that has not been used in the prior art and provides an inventive rescue dual buckle vehicle seat belt, and a new method of assembling.

The invention as described is for a seat belt arrangement in which a belt is stored on the door side of a passenger close to the roof in an automatic winder, and anchored at one end, usually to the floor of the vehicle. When a passenger uses the seat belt, the seat belt is moved downward and across the passenger's lap so that the seat belt is simultaneously across the passenger's lap and extends across the passenger's chest. The two buckle portions on the seat belt are engaged in a releasable or engageable manner.

The inventive seat belt as disclosed and shown is for the type of seat belt that is both a lap seat belt and a chest seat belt. However, for some applications it might be desirable to use it as a simple lap seat belt having buckles at both sides of a person's lap. This would be very important for the airline seats, and other places using only lap seat belts, such as, for example, school buses that have the lap belts only, and other buses or vehicles, such as, used to convey people from the airport to car rental places, to name a few.

It should be appreciated that one end of the inventive seat belt is attached to an automatic winder (not shown) that is anchored to the vehicle, and thus the normal operations of seat belt would not be changed. Furthermore, the added or second buckle is between the floor or frame of the vehicle, and the automatic winder for the seat belt, and thus the ordinary operation of the seat belt would. not be changed.

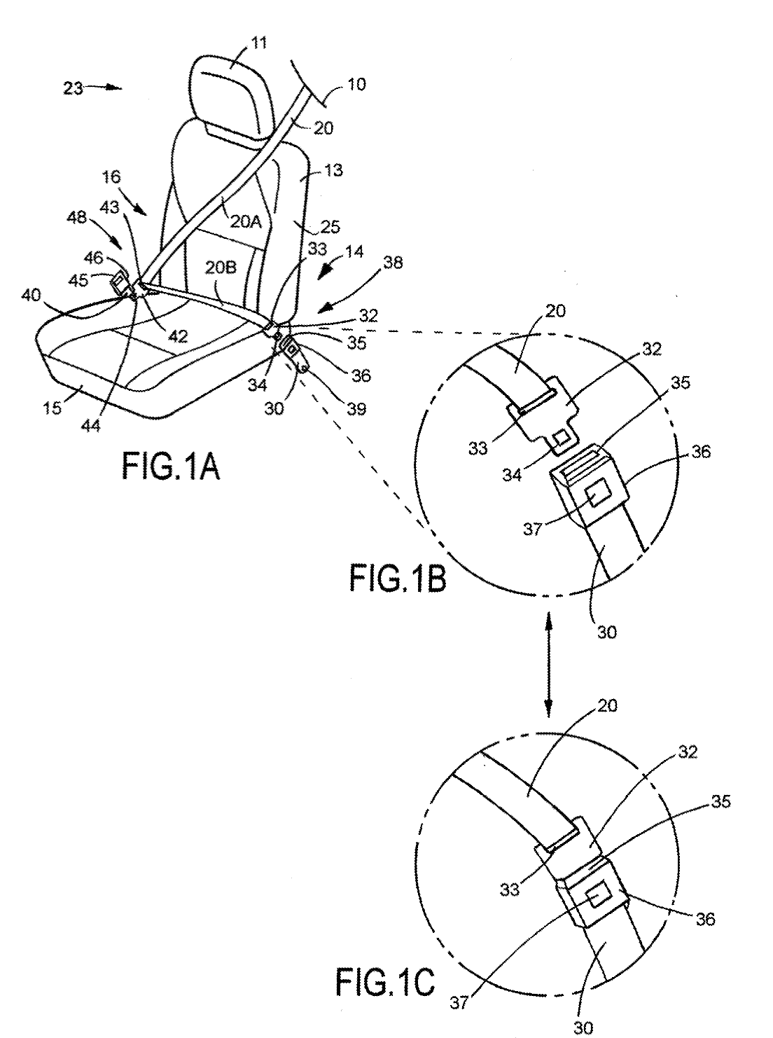

FIG. 1A, illustrates a perspective view of the inventive dual buckle vehicle seat belt system 23, according to a first embodiment of this invention. While, FIG. 1B, illustrates an enlarged view of the inventive dual buckle vehicle seat belt system 23, according to a first embodiment of this invention before the dual buckle assemblies 38, 48, are engaged. And, FIG. 1C, illustrates an enlarged view of the inventive dual buckle vehicle seat belt system 23, according to a first embodiment of this invention after the dual buckle assemblies 38, 48, have been engaged. FIGS. A, 1B, and 1C, further show the inventive rescue dual buckle vehicle seat belt 23, and a method of assembling, and using the same. For cars under manufacturing, the manufacturer should follow the design in FIGS. 1A, 1B, and 1C. As shown in FIG. 1A, the inventive or rescue dual buckle vehicle or car seat belt system 23, of a car or vehicle seat 25, having a seat 15, a seat back 13, an optional headrest II, and a car or vehicle seat belt 20. The car seat 25, has a first or rescue or left seat side 14, for the accommodation of a first or rescue or left buckle assembly 38, and a second or right seat side 16, for the accommodation of a second or regular or standard or right buckle assembly 48. The car or vehicle seat belt 20, is relatively long so as to form a shoulder seat belt section or portion 20A, and a lap seat belt section or portion 20.13.

One end of the car or vehicle scat belt 20, is secured to a frame 10, such as, a car or vehicle frame 10, and the other or opposite end is secured to a first strap 30, via the first or rescue or left buckle assembly 38 One end of the first strap 30, is secured to a secured location, such as, for example, the side of the car seat 25, or the vehicle frame 10, via at least one securing means 39, and the other or opposite end of the first strap 30, has the first or rescue or the left buckle or female latch member 36, having a female receptacle 35, to receive and secure a male latch member 32.

The first or rescue buckle assembly 38, further comprises of a first male latch member 32, having an opening or hole 33, and a first latching means 34, and a first female latch member 36, having a female receptacle 35. The female latch member 36, preferably has an engageable release button 37, more clearly shown in FIGS. 1B, and 1C, which accommodates the penetration of the first male latch member 32, into the first female receptacle 35, and is secured thereto,

The seat belt 20, has a second or sliding male latch member 42, haying a hole or opening 43, for the passage of the seat belt 20, and a second latching means 44. The second or moveable or slideable male latch member 42, is secured to the seat belt 20, so as to allow the securing of the second male latch member 42, to a second female latch member 46, forming the second or regular or standard or right side buckle assembly 48, and which is on the second or regular or standard or right seat side 16, of the car seat 25. The second or regular or standard or right side buckle assembly 48, further comprises of the second female latch member 46, which is secured to one end of a second or regular or standard strap 40, and which strap 40, is secured to a secured location, such as, for example, the side of the car seat 25, or the vehicle frame 10, via at least one securing means 39 (not shown). The other or opposite end of the second or regular or standard strap 40, has the second or regular or standard or rescue or right side buckle or female latch member 46, having a second or female receptacle 45, to receive and secure the second or male latch member 42.

The second or regular or standard or right side buckle assembly 48, further comprises of a second or regular or standard male latch member 42, having an opening or hole 43, and a second latching means 44, and a second or regular or standard female latch member 46, a second female receptacle 45. The female latch member 46, has an engageable release button 37, (not shown) which accommodates the penetration of the second male latch member 42, into the second female receptacle 45, and is secured thereto.

As shown in FIGS. 1A, 1B, 1C, the new pair of a first male latch member 32, and a first female latch member 36, has to be installed, and it can be opened and closed manually by the driver (not shown) in case of emergency. For some applications, as shown in FIG. 1A, the latch tongue or the second male latch member 42, preferably has to have a bigger hole or opening 44, so that the latch tongue 42, can go through into the second female receptacle 35, and be held securely and releaseably therein.

The inventive dual buckle vehicle seat belt system 23, has a seat belt system 23, for use with a vehicle seat which includes the three point belt system forming a lap belt 20B, and a shoulder belt 20A, and further includes a second buckle assembly system 38, 48, to form a new three point system. The seat belt system 23. allows an easy to reach position for the two buckle assemblies 38, 48, so as to encourage seat belt usage, and an easy and convenient engaging and disengaging means. The system 23, further includes two buckle assemblies 38, 48, on the opposite sides of the car seat 25, with each having an independent engage and release mechanism 37, which provides for an automatic release to each buckle assemblies 38 48, when so desired by the user, operator (not shown).

As disclosed the inventive attachable/detachable three point seat belt system 23, requires the wearer or user to place the shoulder belt portion 20A, over the person or user's chest, and then attach or fasten a first buckle assembly 38, 48, and then attach or fasten a second buckle assembly 38, 48, over the user or wearer's body or lap. This the inventive attachable I detachable three point seat belt system 23, addresses the three point seat belt system 23, which will operate at any seating position within the vehicle, such as, for example, a front seat, a rear seat, a side seats, and/or a center seat within the vehicle.

With the male seat belt latch tongue 32, 42, extending from one end, and a female seat belt latch receptacle 36, 46, extending from the opposite end, the seat belt system 23, can be installed in an existing, conventional three point seat belt system in a vehicle by inserting or securing a second buckle assembly 38, 48, to a vehicle and then anchoring the strap 30, 40, to the inside of the frame or floor of the vehicle 10.

FIG. 1A, has been shown with an imaginary person sitting on car seat 25, and with the seat belt 20, coming over the shoulder from the top or upper left side and is being secured to the second buckle assembly 48, which is at the bottom right of the occupant, while the first buckle assembly 38, is at the bottom left side of the passenger. However, it should be understood that for the person sitting in the adjacent car seat 25, (not shown), the seat belt 20, would originate over the person's top right shoulder and then be secured via the second buckle assembly 48, (not shown) which would be on the person's bottom left side, while the first buckle assembly 38, (not shown) would be at the bottom right side of the person sitting on the car seat 25 (not shown).

In case of an accident, some of the existing seat belt systems get locked and that prevents the driver or passenger to get out of the vehicle. This situation can be critical especially if a car or vehicle has caught fire. Thus, the occupant or user can use the manual rescue dual buckle assembly 38, 48, to release the seat belt 20, and get out of the car or vehicle 10.

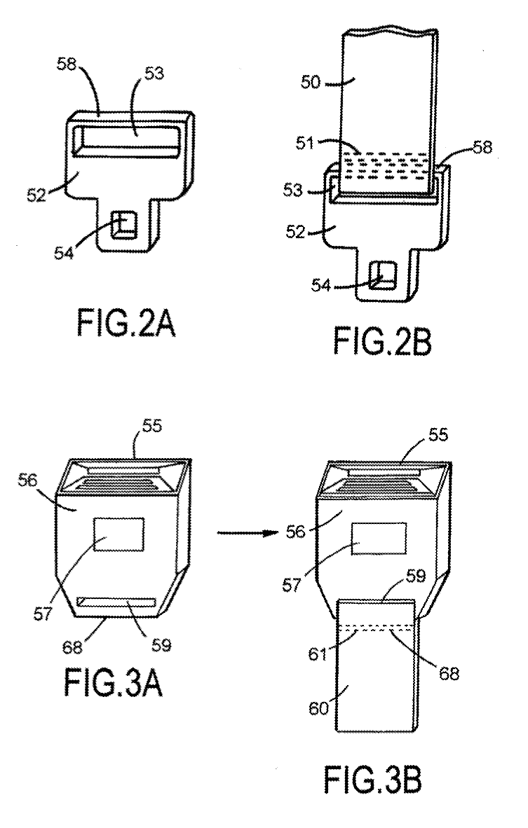

FIG. 2A, illustrates an enlarged view of the male portion 52, of the inventive dual buckle vehicle seat belt system 23, according to a first embodiment of this invention before the male member 52. is engaged to a belt 20, 30, 40, 50, 60. While FIG. 2B, illustrates an enlarged view of the male portion 52, of the inventive dual buckle vehicle seat belt system 23, according to a first embodiment of this invention after the male member 52, has been engaged with a seat belt 50. The male latch member 52, has a latching means 54, and an opening or hole 53, and a latch bar 58. The seat belt 20, 30, 40, 50, 60, is attached to the male latch member 52, by passing or inserting it through the hole or opening 53, and securing it around the latch bar 58, via at least one securing, means 51.

FIG. 3A. illustrates an enlarged view of the female portion 56, of the inventive dual buckle vehicle, seat belt system 23, according to a first embodiment of this invention before the female member 56, is engaged to a short belt 20, 30, 40, 50, 60. While, FIG. 3B, illustrates an enlarged view of the female portion 56, of the inventive dual buckle vehicle seat belt system 23, according to a first embodiment of this invention after the female member 56, has been engaged with a short belt 60. The female latch member 56, has a female receptacle 55, an opening or hole 59, a latch bar 68, and an engageable release button 57. The seat belt 20, 30, 40, 50, 60, is attached to the female latch member 56, by passing. or inserting it through the hole or opening 59, and securing it around the latch bar 68, via at least one securing means 61.

For cars or vehicles that are already manufactured, the implementation in FIGS. 2A, 2B, 3A, and 3B, should be followed. As shown in FIGS. 2A, 2B, 3A, and 3B, only male latch member 52, and female latch member 56, should he manufactured, and then they can be installed in the workshop by cutting any of the seat belts of the prior art, at the most bottom side of the seat, and then by attaching male latch member 52, to seat belt 50, by at least one securing means 51, such as, sewing it at securing means 51. Also, one would attach female latch member 56, to seat belt 60, in the same way, and it is also secured via at least one securing means at 61, such as by sewing 61. Thus, the seat belt, once assembled, will then be similar to the seat belt system as shown in FIGS. 1A, 1B, and 1C.

As stated earlier that for a car or vehicle that has already been manufactured one would buy the male latch member 52, and the female latch member 56, and then install them, as already illustrated in FIGS. 1A, 1B, and 1C. The male latch member 52, has an opening or a hole 53, for the seat belt 50, and a latching means 54. The seat belt 50, is secured to the male latching member 52, via at least one securing means 51, such as, by stitching 51, Similarly, the female latch member 56, has a hole 59, for the seat belt 60, and a female receptacle 55. The seat belt 60, is secured to the female latching member 56, via at least one securing means 61, such as, by stitching 61. The female latch member 56, has a engageable release button 57, which accommodates the penetration of the male latch member 52, via latching means 54, into the female receptacle 55, and is engageably and releaseably secured thereto.

It should be appreciated that two buckles 32, 42, or 36, 46, or any combination thereof, are on the same seat belt strap 20, for the novel dual buckle vehicle seat belt system 23, of this invention, and that one or first end of the seat belt 20, is secured to a winder (not shown) within the frame 10, while the opposite or second end has a buckle 32, 42, 36, 46, secured thereto, and a second buckle 32, 42, 36, 46, is free to slideably move along the seat belt 20, from the first or one end to the opposite or second end of the seat belt 20,

The cross-sectional shape of the hole or opening 33, 43, 53, 59, for the seat belt 20, 30, 40, 50, 60, is preferably selected from a group comprising a triangular-shape, a square-shape, a rectangular-shape, a circular-shape, an oval-shape, a multisided-shape, a polygonal-shape, and combinations thereof, to name a few.

The material for the seat belt or strap, 20, 30, 40, 50, 60, is preferably selected from a group comprising a cotton material, a composite material, a nylon-type material, a polymer material, a fibrous material, and combinations thereof, to name a few.

It should be understood that the various features shown and described are also applicable to the seat next to the driver's seat, such as, a passenger's seat, or a seat at any other location.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed: Is:

1. In a known belt system for restraining a passenger in a seat such as in an automobile, comprising:
a seat belt attached to the vehicle generally above the passenger on a mechanism for automatically winding, and storing the seat belt for storage between uses in a storage position on the door side oldie passenger, and attached at another end to the floor directly or indirectly to an anchor; and
a first buckle portion slideably attached to the seat belt, and adapted to engage releasably to a second buckle portion attached to the seat so that movement of the seat belt by the passenger from the storage position to engage the first buckle portion in the second buckle portion results in the seat belt positioned both across the passenger's lap, and across the passenger's chest;
the improvement comprising:
adding, a third buckle portion to said seat belt near said anchor, and adding a fourth buckle portion to said seat belt at the end of the seat belt near the anchor; said third and fourth buckle portions releasably engaging and adapted to be disengaged manually;
whereby, for an emergency the passenger can be released for the seat belt easily by the highly accessible third and fourth buckle portions near the door.

2. The known belt system for restraining a passenger in a seat such as in an automobile of claim 1, wherein the buckle portion has an opening, for the passage of the belt, and wherein the cross-sectional shape of the opening is selected from a group consisting of a triangular-shape, a square-shape, a rectangular-shape, a circular-shape, an oval-shape, a multisided-shape, a polygonal-shape, and combinations thereof.

3. The known belt system for restraining a passenger in a seat such as in an automobile of claim 1, wherein the material for the seat belt is selected from a group consisting of a cotton material, a composite material, a nylon-type material, a polymer material, a fibrous material, and combinations thereof.

4. A rescue dual buckle vehicle seat belt system, comprising.
(a) a seat belt, having a first end and a second end, and wherein said first end is secured to a frame of a vehicle, and wherein said second end is secured to a first buckle;
(b) a second buckle slideably secured to said seat belt, such that said second buckle slideably moves from said first end to said second end of said seat belt; and
(c) a car seat, said car seat having a first buckle engaging means on a first side of said car seat, and a second buckle engaging means on a second side of said car seat, and wherein said first buckle engaging, means engageably and releasably engages said first buckle, and wherein said second buckle engaging means engageably and releasably engages said second buckle.

5. The rescue dual buckle vehicle seat belt system, of claim 4, wherein said first side and said second side are on the opposite side of said car seat.

6. The rescue dual buckle vehicle seat belt system, of claim 4, wherein said car seat has a. back portion and a seat portion, and wherein said first, end of said seat belt is secured above said back portion.

7. The rescue dual buckle vehicle seat belt system, of claim 4, wherein said car seat has a back portion and a seat portion, and wherein said first buckle engaging means are secured said seat portion.

8. rescue dual buckle vehicle seat belt system, of claim 4, wherein said car seat has a back portion and a seat portion, and wherein said first buckle engaging means are secured said frame.

9. The rescue dual buckle vehicle seat belt system, of claim 4, wherein said car seat has a back portion and a. seat portion, and wherein said second buckle engaging means are secured said seat portion.

10. The rescue dual buckle vehicle seat belt system, of claim 4, wherein said car seat has a back portion and a seat portion, and wherein said second buckle engaging means are secured said frame.

11. The rescue dual buckle vehicle seat belt system, of claim 4, wherein said car seat has a head rest.

12. The rescue dual buckle vehicle seat belt system, of claim 4, wherein said car seat is selected from a group consisting of a driver seat, a passenger seat, a front seat, a back seat, a middle seat, and a bench seat.

13. The rescue dual buckle vehicle seat belt system, of claim 4, wherein said first buckle is one of a male buckle member, or a female buckle member.

14. The rescue dual buckle vehicle seat belt system, of claim 4, wherein said second buckle is one of a male buckle member, or a female buckle member,

15. The rescue dual buckle vehicle seat belt system, of claim 4, wherein said first buckle engaging means is one of a male buckle member, or a female buckle member.

16. The rescue dual buckle vehicle seat belt system, of claim 4, wherein said second buckle engaging means is one of a male buckle member, or a female buckle member,

17. The rescue dual buckle vehicle seat belt system, of claim 4, wherein said first buckle and said second buckle have an opening for the passage of said seat belt, and wherein the cross-sectional shape of said opening is selected from a group consisting of a triangular-shape, a square-shape, a rectangular-shape, a circular-shape, an oval-shape, a multisided-shape, a polygonal-shape, and combinations thereof.

18. The rescue dual buckle vehicle seat belt system, of claim 4, wherein a material for said seat belt is selected from a group consisting of a cotton material, a composite material, a nylon-type material, a polymer material, a fibrous material, and combinations thereof.

19. A rescue dual buckle vehicle seat belt system, comprising:
(a) a seat belt, having a first end and a second end, and wherein said first end is secured to a frame of a vehicle, and wherein said second end is secured to a first buckle;
(b) a second buckle slideably secured to said seat belt, such that said second buckle slideably moves from said first end to said second end of said seat belt;
(c) a car seat, said car seat having a first buckle engaging means on a first side of said car seat, and a second buckle engaging means on a second side of said car seat, and wherein said first buckle engaging means engageably and releasably engages said first buckle, and wherein said second buckle engaging means engageably and releasably engages said second buckle; and
(d) wherein said car seat has a back and a. seat, and wherein said first end is secured to said frame above said back, while said first buckle engaging means and said second buckle engaging means are secured below said seat to said frame.
